(19) United States
(12) Patent Application Publication
(10) Pub. No.: US 2008/0204671 A1
(43) Pub. Date: Aug. 28, 2008

(54) Operating element with freely programmable symbols for a motor vehicle

(76) Inventor: Martin Jeitner, Ostheim (DE)

Correspondence Address: Muncy, Geissler, Olds & Lowe, PLLC, P.O. BOX 1364, FAIRFAX, VA, 22038-1364, US

(21) Appl. No.: 12/018,189

(22) Filed: Jan. 22, 2008

Related U.S. Application Data
(63) Continuation of application No. PCT/EP2006/007047, filed on Jul. 18, 2006.

(30) Foreign Application Priority Data
Jul. 22, 2005 (DE) 102005034307
Sep. 12, 2005 (DE) 102005043588

(51) Int. Cl. G03B 21/22

(52) U.S. Cl. 353/74

(57) ABSTRACT

An operating element with freely programmable symbols is provided for a motor vehicle, having a transparent keycap movably accommodated in a housing, a light source arranged in the operating element, a means for parallelizing the light emitted by the light source, and a programmable display element that can be transilluminated by the parallelized light, wherein the display element is arranged behind the keycap in such a manner that the symbols displayed by the display element are projected onto the keycap, wherein the means for parallelizing the light is designed as a concave mirror, and in that the light source is located between the display means and the concave mirror.

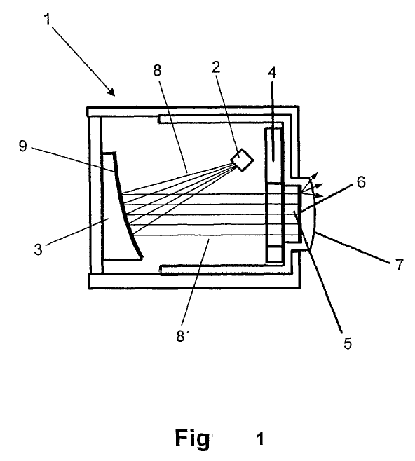

This nonprovisional application is a continuation of International Application No. PCT/EP2006/007047, which was filed on Jul. 18, 2006, and which claims priority to German Patent Application Nos. DE 102005034307 and DE 102005043588, which were filed in Germany on Jul. 22, 2005 and Sep. 12, 2005, respectively, and which are both herein incorporated by reference.

### BACKGROUND OF THE INVENTION

1. Field of the Invention

The present invention relates to an operating element, in particular for a motor vehicle, with freely programmable symbols.

2. Description of the Background Art

In many motor vehicles, complex electronics can be encountered, the operation of which requires a number of input and output elements. For reasons of space and improved ergonomics, it is desirable to have operating elements which are not assigned a specific function, but instead are allocated a variable meaning depending on the system status. In order to indicate to the user the meaning currently assigned to the operating element, it is known to make the symbols shown on the operating element freely programmable.

Thus, for example, the unexamined patent application DE 103 42 142 A1 discloses an operating element with freely programmable symbols, in which the light from a light source is parallelized by means of a lens and transmitted through a display. The light then strikes the keycap of the operating element, where it is perceived by the user.

A disadvantage of this solution is the space required for parallelizing the light. Consequently, the object of the present invention is to provide an operating element with programmable symbols that is structurally simple, easy to manufacture, and requires only a small amount of space.

### SUMMARY OF THE INVENTION

It is therefore an object of the present invention to provide an operating element with freely programmable symbols for a motor vehicle that has a transparent keycap movably accommodated in a housing, a light source arranged in the operating element, a means for parallelizing the light emitted by the light source, and a programmable display element that can be transilluminated by the parallelized light, wherein the display element is arranged behind the transparent keycap in such a manner that the symbols displayed by the display element are projected onto the transparent keycap, the means for parallelizing the light is designed as a concave mirror, and the light source is located between the display means and the concave mirror.

In this connection, the light source can be located at the focal point of the concave mirror. The transparent keycap is preferably made of plastic. The concave mirror achieves the result that the light source and the display element are located on the same side of the concave mirror, while in the prior art operating element the lens is located between the light source and the display. The result is a significantly reduced installation depth of the inventive operating element.

In an embodiment, the concave mirror includes a reflectively coated carrier material. In this connection, the carrier material has a concave curvature in the manner of a conventional concave mirror. Alternatively, the carrier material represents a block of any desired shape with a curved formation. The advantage of this embodiment is that the shaping of the carrier material achieves a precise orientation of the concave mirror in the operating element. In addition, the concave mirror can include an optical module [Lichtstein in German] with an integrated reflective layer or with a reflective layer behind the optical module. In this connection, the reflective layer includes a reflective film, or is vapor deposited by a PVD process. An optical module is a transparent light guide. As a result of the combination of a reflective layer with an optical module, the optical path can be further optimized, for example to produce a more parallel bundle of rays with an even smaller overall size of the unit.

In another embodiment, the display element is designed as a liquid crystal display (LCD). LCDs are inexpensive standard components that ensure a good image quality at low cost.

At least one light emitting diode (LED) can be used as light source. An LED is characterized by low power consumption and correspondingly little generation of heat. In addition, LEDs can be very compact in implementation, for which reason they can almost be considered a point source of light. The smaller the spatial extent of the light source, the smaller the divergence of the reflected beam beyond the concave mirror. A small divergence, which is to say as parallel a light beam as possible, improves the image quality of the LCD.

In another embodiment, the light source has multiple LEDs. In advantageous fashion, each LED emits light of a different color, preferably a primary color. Any desired color mixtures can be produced by controlling the LEDs. If one red, one green, and one blue LED are used, a wide color spectrum can be covered by additive mixing of colors.

In another embodiment, the operating element has a scattering film for scattering the light from the light source transmitted through the display element. Since the light passed through the display element is as parallel as possible, as described above, it normally must be deflected in order to be visible from different directions of view. This is accomplished by means of a scattering film, which scatters the light in a defined angular range. This angular range is preferably kept as large as possible, so that, for example, both the driver and passenger of the motor vehicle can see the symbol. Alternatively, a scattering angle range is possible that preferentially takes in the driver's head.

In another embodiment, the operating element has an optical module arranged behind the display element relative to the optical path. This has the advantage that any divergence of the light beam that may be present is smaller in the optical module than in air on account of the refraction. As a result, less spreading of the light beam takes place in the optical module than for propagation in air with the same path length.

In another embodiment, the display element is oriented such that the parallel light beam is not perpendicular to the surface of the display element. This exploits the fact that a display element, especially an LCD, has different image-forming properties, for example with respect to contrast, depending on the angle at which the incident light strikes.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawings which are given by way of illustration only, and thus, are not limitive of the present invention, and wherein the single FIGURE shows a cross-sectional view of an operating element according to an embodiment of the present invention.

### DETAILED DESCRIPTION

Shown in the FIGURE is a cross-section through an inventive operating element 1, such as is used in the instrument panel of a motor vehicle, for example. This operating element 1 has an LED 2, a concave mirror 3, and an LCD 4. The concave mirror 3 is a plastic carrier material with a curved reflecting surface 9. The LED 2 is arranged in a region between the LCD 4 and the concave mirror 3, preferably in the focal point of the concave mirror 3.

A divergent cone of rays 8 emerges from the LED 2, strikes the curved surface 9 of the concave mirror 3, and is reflected as a parallel or nearly parallel bundle of rays 8′. The bundle of rays 8′ penetrates the LCD 4, which is controlled by a control unit (not shown) in such a way that it shows a desired set of symbols. Consequently, the symbol displayed on the LCD 4 is projected through the parallel bundle of rays onto the keycap 7.

Arranged behind the LCD 4 with respect to the optical path of the light 8 or 8′, which is to say between the LCD 4 and the keycap 7, is an optical module 5. This optical module includes a transparent light guide with a high refractive index, which reduces any remaining residual divergence of the ray bundle 8′.

The visible light transmitted through the display 4 and the optical module 5 strikes a scattering film 6, which scatters the light in such a way that it can be perceived by a user of the operating element 1. The scattering film 6 is arranged on either the optical module 5 or the keycap 7. For the user of the operating element 1, the impression is produced that the symbol is displayed on the keycap 7. It is especially advantageous that the displayed symbol can be changed by programming the LCD 4.

The inventive operating element 1 can be any desired type of operating element, for example a pushbutton, a rotary control, or a combination of the two.

Preferably, the LED 2 and the concave mirror 3 are fixed in their arrangement with respect to the operating element 1. The keycap 7 is moved relative to the operating element 1 when said keycap is operated. Preferably, the LED 4, the optical module 5, and the scattering film 6 are permanently attached to the keycap 7, and thus can move together with the keycap 7 relative to the operating element 1. This is especially advantageous when the operating element 1 is a pushbufton. Alternatively, the LCD 4 and/or the optical module 5 and/or the scattering film 6 can be arranged to be stationary with respect to the operating element 1, which is especially advantageous when the operating element 1 is a rotary control.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An operating element with freely programmable symbols for a motor vehicle, the operating element comprising:
a transparent keycap movably accommodated in a housing;
a light source arranged in the operating element;
a device for parallelizing the light emitted by the light source; and
a programmable display element that is transilluminated by the parallelized light,
wherein the display element is arranged behind the keycap in such a manner that the symbols displayed by the display element are projected onto the keycap,
wherein the device for parallelizing the light is designed as a concave mirror, and
wherein the light source is located between the display element and the concave mirror.

2. The operating element according to claim 1, wherein the light source is located at the focal point of the concave mirror.

3. The operating element according to claim 1, wherein the concave mirror includes a reflectively coated carrier material.

4. The operating element according to claim 1, wherein the display element is an LCD.

5. The operating element according to claim 1, wherein the light source is formed by one or more LEDs.

6. The operating element according to claim 1, further comprising a scattering film for scattering the light from the light source transmitted through the display element.

7. The operating element according to claim 1, further comprising an optical module arranged behind the display element relative to the optical path.

8. The operating element according to claim 1, wherein the display element is oriented such that the parallel light beam is not perpendicular or slightly inclined to the surface of the display element.

9. The operating element according to claim 1, wherein the mirror includes an optical module with an integrated reflective layer or with a reflective layer behind the optical module.
